(19) United States
(12) Patent Application Publication
(10) Pub. No.: US 2023/0311260 A1
(43) Pub. Date: Oct. 5, 2023

(54) POWER TOOL SYSTEM AND METHOD FOR CONNECTING A VACUUMING DEVICE TO A POWER TOOL

(71) Applicant: Hilti Aktiengesellschaft, Schaan (LI)

(72) Inventors: Gabor VIDA, Chur (CH); John Van TAACK-TRAKRANEN, Muenchen (DE)

(21) Appl. No.: 17/790,818

(22) PCT Filed: Dec. 14, 2020
(86) PCT No.: PCT/EP2020/085945

§ 371 Date: Jul. 5, 2022

(30) Foreign Application Priority Data
Jan. 10, 2020 (EP) 20151150.8

(51) Int. Cl. B23Q 11/00; B25F 5/02

(52) U.S. Cl. CPC B23Q 11/0046; B23Q 11/0071; B25F 5/026

(57) ABSTRACT

A power tool system and to a method for connecting a vacuuming device to a power tool. The system comprises a power tool having a tool, a vacuuming device for extracting dust that arises when working with the power tool, and a suction connection device, wherein the suction connection device is arranged between the tool of the power tool and the power tool and is connectable to the power tool in that a toothing of the power tool is able to be engaged with a mating toothing on the suction connection device. The present invention advantageously makes it possible for a suction hose that connects the vacuuming device and the suction connection device of the power tool system together to be able to be fixed relative to a handle of the power tool. Furthermore, an angle between the suction hose and the handle of the power tool can be set particularly easily.

The present invention relates to a power tool system and to a method for connecting a vacuuming device to a power tool.

### BACKGROUND OF THE INVENTION

Power tools such as core drills, with which drilling cores can be separated from a substrate, are known from the prior art. It is also known that the dust that arises when working with a power tool can be extracted from the working area of a power tool with the aid of a vacuuming device, in order to prevent the dust from getting into the airways of a user of the power tool.

### SUMMARY OF THE INVENTION

In particular, two concepts are known from the prior art, with which, in the case of core drills, extraction of the dust that accumulates is intended to be achieved. According to a first concept, the dust is extracted through the shaft of the core drill. This concept is associated with the drawback that it is not possible to use a starting aid that is fixedly mountable on the core drill when extraction takes place through the shaft of the core drill. A starting aid that is usable as an alternative and is not mountable in a fixed manner can be used for example at a front tip of the core bit or of the socket cutter. However, such an alternative starting aid at the front tip of the core bit or of the socket cutter is merely plugged in and has to be removed after initial drilling, when the drilling operation is intended to be continued. Such a procedure is very time-consuming and labor-intensive, however, and reduces working efficiency when creating the drilling cores.

According to a second concept, it is proposed that the dust that accrues when working with the power tool is extracted through a rear wall of the tool of the power tool, i.e. of the core bit or of the socket cutter. However, this second concept is associated with the drawback that, in the available solutions, a gap arises between the power tool and extraction. As a consequence, it is possible for the suction hose, which connects the tool and the vacuuming device together, to sag in a random manner or under the force of gravity, this possibly being very inconvenient in various applications and representing an undesired imposition for the user of the power tool.

It is an object of the present invention to overcome the above-described drawbacks of conventional core drilling systems and to prevent undesired sagging of the suction hose. Those skilled in the art would also appreciate it if a system and a method for connecting a vacuuming device to a power tool could be provided in which the suction hose, which connects the vacuuming device and the power tool together, could be fixed relative to a side handle of the power tool. A further object underlying the present invention is to provide a possible way of setting an angle between the suction hose and the handle of the power tool in a particularly simple manner.

The present invention provides a system for connecting a vacuuming device to a power tool, wherein the system comprises the following components:
a power tool having a tool,
a vacuuming device for extracting dust that arises when working with the power tool,
a suction connection device.

The system is characterized in that the suction connection device is arranged between the tool of the power tool and the power tool and is connectable to the power tool in that a toothing of the power tool is able to be engaged with a mating toothing on the suction connection device. The invention is associated with the advantage that a user can set a position of the suction hose with respect to the power tool and with respect to the side handle as desired in a particularly simple manner. As a result, the suction hose can be guided in a desired manner, wherein its position can be fixed or freely movable. Furthermore, the invention makes it possible for rotation of the suction hose about the drilling axis to be able to be prevented effectively. According to the invention, it is very particularly preferred that the system can be used to connect a vacuuming device to a power tool.

The power tool can be in particular a core drill, with which drilling cores can be cut out of or separated from a substrate to be machined, such as rock, concrete or masonry. Accordingly, the tool of the power tool can be a core bit or a socket cutter. When the power tool is formed by a core drill, the proposed system can preferably be referred to as a core drilling system. The core bit or socket cutter can be studded with diamond fragments in order to improve the cutting performance of the tool. Preferably, according to the invention, the suction connection device can also be referred to as a suction head. The suction head is arranged between the tool of the power tool and the power tool, wherein the suction connection device can have, on the side facing the power tool, a mating toothing or a mating contour that can cooperate with the toothing or a contour on the power tool such that a connection is established between the suction head and power tool. Preferably, the suction connection device can also be considered to be a connecting piece between the power tool and the tool, which is designed in particular to bridge a possible gap between the core drill, for the one part, and the core bit and/or socket cutter, for the other part. In particular, according to the invention, it is preferred that the gap is bridged in order to fix the core bit or the socket cutter. Such bridging is provided in neither of the two extraction concepts for core drills that are known from the prior art.

The region in which the connection between the suction head and power tool is established is, according to the invention, preferably also referred to as the second connecting region. On the power tool side, the suction connection device faces in particular a handle of the power tool. In other words, it may be preferred according to the invention for the suction connection device to be arranged between the tool of the power tool and a handle of the power tool. The handle comprises preferably a handle piece, with which the handpiece of the handle can be fastened to a housing of the power tool. Preferably, the handle can also be referred to as a side handle of the power tool.

The connection between the suction connection device and power tool or handle of the power tool is established by the cooperation of a toothing and a mating toothing, wherein the unit made up of the toothing and mating toothing is referred to preferably as a locking mechanism according to the invention. The locking mechanism is preferably designed to connect the power tool or the handle of the power tool to the suction head. In particular, a gap between the power tool and the tool can be bridged by the locking mechanism. In particular, the locking mechanism is located in a second connecting region between the suction connection device and power tool. According to the invention, it is particularly preferred that the toothing is integrated in a handle piece of the power tool. This allows a locking mechanism that is particularly simple in terms of construction.

The suction connection device also has a first connecting region, wherein the suction head can be connected to the tool of the power tool in this first connecting region. The suction head furthermore has a second connecting region, wherein the suction connection device can be connected to the power tool or the handle of the power tool in this second connecting region. According to the invention, it is preferred that the first and the second connecting region are arranged along a substantially central axis, which is formed for example by the drive axis of the tool of the power tool. This drive axis can, according to the invention, also be referred to as shaft or drilling axis.

Preferably, the suction head also has a third connecting region, wherein the suction connection device can be connected to the vacuuming device in this third connecting region. This third connecting region can preferably be formed by or comprise an extraction nozzle. According to the invention, it is very particularly preferred that the suction connection device comprises a connection for a vacuuming device. Theoretically, a central axis can pass through the third connecting region or through the extraction nozzle, wherein this virtual central axis is substantially perpendicular to the central axis along which the first and the second connecting region are arranged. The term “substantially” is not an unclear term for a person skilled in the art because a person skilled in the art knows for example that, in the context of the present invention, even small deviations from exact mathematical orthogonality, for example in a range from 0 to 5 degrees, are intended to be covered by the term “substantially perpendicular”.

According to the invention, it is preferred that the suction connection device and the vacuuming device are connected together by a suction hose. A first end of the suction hose can preferably be connected to the suction connection device or the third connecting region of the suction connection device and lead to the vacuuming device. Preferably, a second end of the suction hose can be connected to the vacuuming device. The present invention advantageously makes it possible for the suction hose to be able to be fixed relative to the handle of the power tool. Furthermore, the suction hose can be adjusted in a particularly simple and uncomplicated manner to an angle relative to the handle of the power tool by the invention. In other words, a significant advantage that is achieved by the present invention is that an angle between the suction hose and handle of the power tool can be set particularly easily. This is achieved in particular by the provision of the locking mechanism between the suction connection device and power tool, wherein, as a result, a releasable and/or angularly settable connection between the power tool or the handle thereof and the suction head can advantageously be established. Provision is made that the locking mechanism has a toothing or a contour that can be engaged with a mating toothing or mating contour on the power tool. According to the invention, it is preferred that the toothing is designed to engage in the mating toothing of the suction connection device. As a result, a preferably adjustable, i.e. variable connection can be established between the handle of the power tool and the suction connection device.

As a result of the provision of the locking mechanism between the suction connection device and power tool, it is possible in particular for the suction hose, which connects the vacuuming device and the power tool together, to be able to be fixed relative to the side handle of the power tool. Furthermore, the invention advantageously provides a possible way of setting an angle between the suction hose and the handle of the power tool in a particularly simple manner. In particular, as a result of the provision of the locking mechanism, at least three fastening stages can be provided, which define different fastening modes between the suction connection device and power tool. According to the invention, it is preferred that the three fastening stages can be set by the number of rotations of the side handle when it is screwed on. Preferably, in a first fastening stage, the handle of the power tool and the suction connection device can be substantially fixed together. In a second fastening stage, the handle of the power tool and the suction connection device can form a unit that is configured to be rotatable relative to the power tool. According to the invention, it is preferred that in a third fastening stage, the suction connection device is configured to be rotatable relative to the handle of the power tool. In other words, in a first fastening stage, the handle of the power tool and the suction connection device are fastened together. In a second fastening stage, the side handle of the power tool and the suction head can be rotated jointly relative to the power tool. In a third fastening stage, the suction head can be twisted relative to the side handle of the power tool. This can preferably be achieved by additional actuation at the toothing on the handle piece of the power tool. In particular, as a result of the additional actuation at the toothing, it is possible for the toothing to be retracted. As a result, in particular a fixed position will be reached, which is in particular either a latching or an open position.

According to the invention, it is preferred that the fastening stages are settable by a number of rotations of the handle of the power tool. In other words, the fastening stages can be set with respect to one another depending on the arrangement of the toothing and mating toothing. By positioning the toothing and mating toothing with respect to one another, it is therefore possible preferably to define whether the handle of the power tool and the suction connection device are substantially fixed together or the handle of the power tool and the suction connection device form a unit that is configured to be rotatable relative to the power tool, or whether the suction connection device is intended to be configured to be rotatable relative to the handle of the power tool.

According to the invention, it is preferred that the toothing is integrated in the handle of the power tool. As a result of this configuration of the invention, a particularly compact power tool that is easy to handle as a result can be provided.

In a further aspect, the invention relates to a method for connecting a vacuuming device to a power tool, which comprises the following steps:
a) providing a power tool having a tool,
b) providing a suction connection device arranged between the tool of the power tool and the power tool,
c) establishing a connection between the suction connection device and the power tool, in that a toothing of the power tool is engaged with a mating toothing on the suction connection device.

The terms, definitions and technical advantages introduced for the power tool system apply in an analogous manner to the proposed method. Advantageously, the proposed method makes it possible to adjust an angle between the suction hose and the handle of the power tool in a particularly simple and uncomplicated manner. Preferably, the proposed method can be carried out with the proposed system. In particular, the power tool has a tool. Furthermore, the power tool has a toothing, which can be engaged with a mating toothing on the suction connection device. Preferably, the suction connection device is arranged between the tool of the power tool and the power tool, such that it represents preferably a connecting piece between the tool and power tool, with which a gap between the tool and power tool can be bridged.

In the context of the invention, a handle piece for a core drill is disclosed, which can be used in particular for dry drilling. In this case, in a particularly preferred configuration of the invention, the core drill can be used for socket cutting. When the tool of the power tool is studded with diamonds, the drill can preferably also be referred to as a diamond core drill. According to the invention, it is preferred that, using a locking mechanism and a mating contour, which is preferably present in the suction head, the handle piece of the power tool fixes the tool handle and allows a settable angle between the suction connection and handle.

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

### BRIEF DESCRIPTION OF THE DRAWINGS

In the figures, identical and similar components are denoted by the same reference signs.

In the figures:

FIGS. 1 to 3 show views of preferred configurations of the handle of a power tool

FIGS. 4 to 6 show views of preferred configurations of the suction connection device

FIG. 7 shows a view of a preferred configuration of the suction connection device, locking mechanism and handle of the power tool

### DETAILED DESCRIPTION

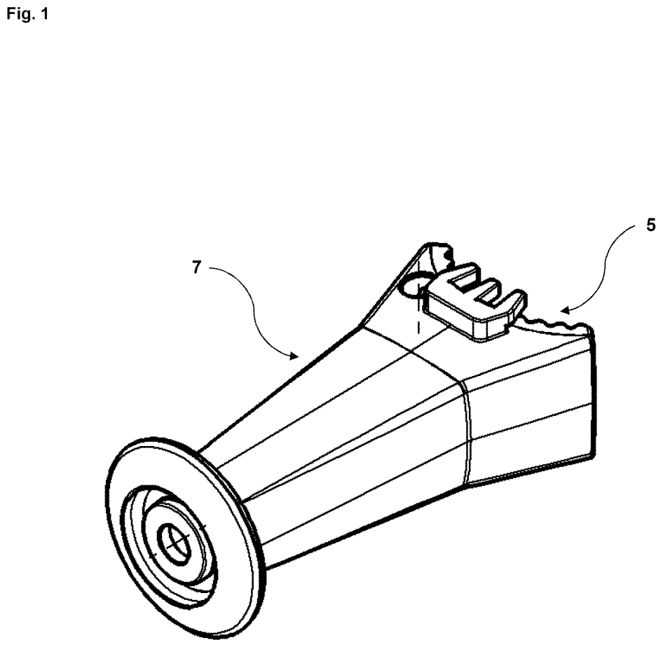

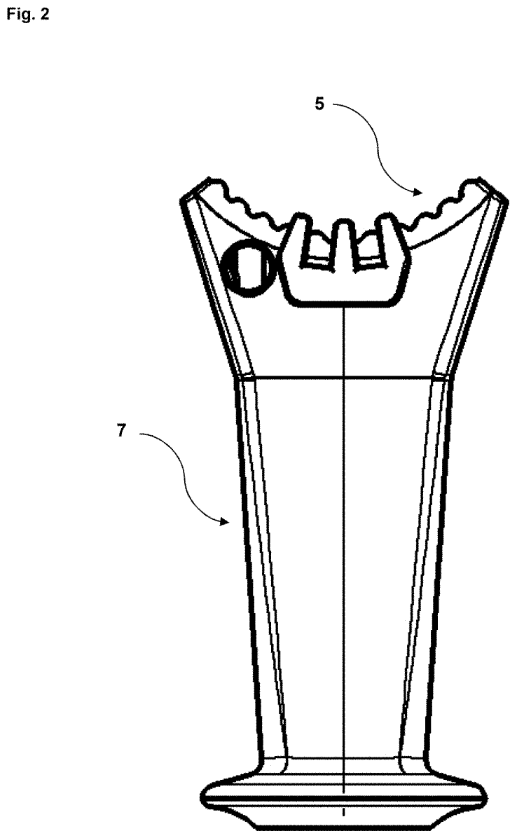

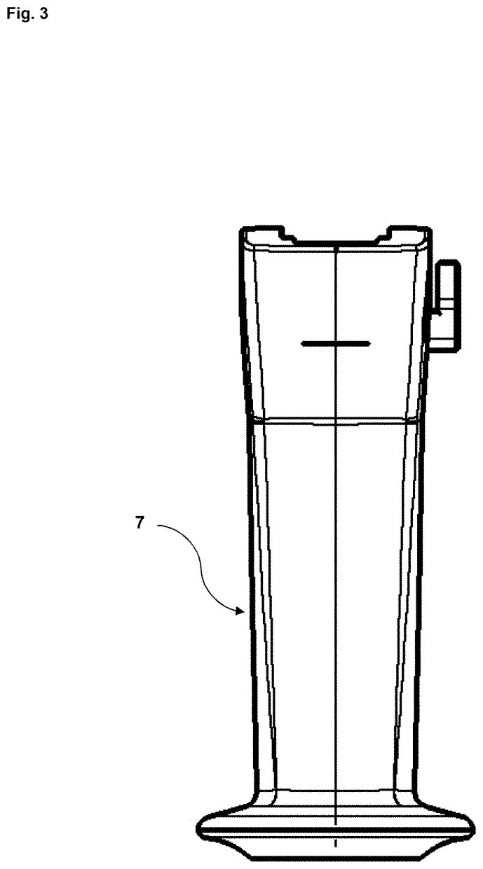

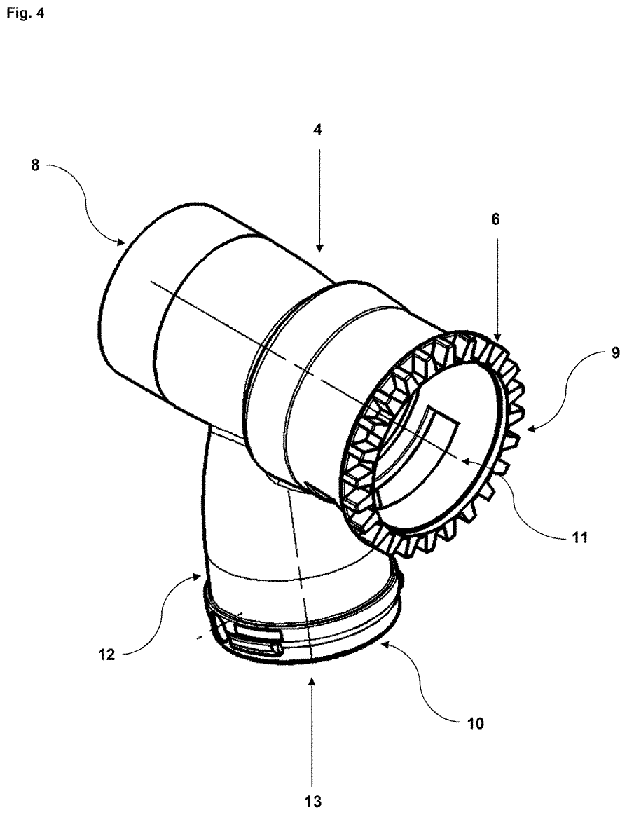

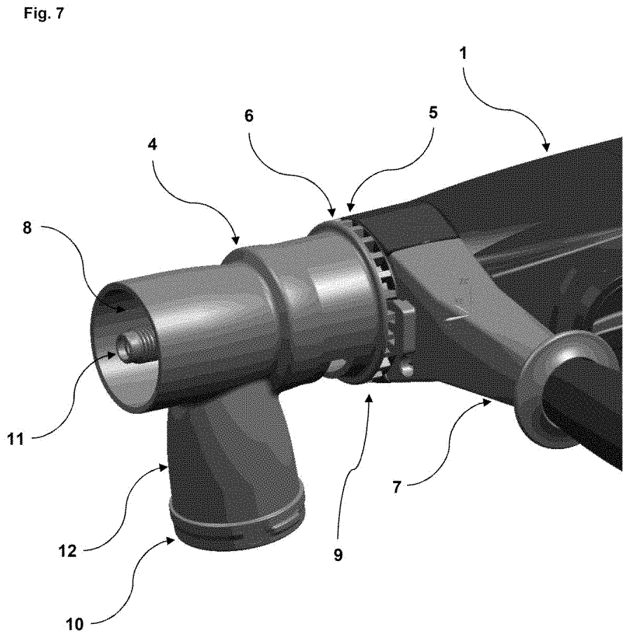

FIGS. 1 to 3 show views of preferred configurations of the handle (7) of a power tool (1, illustrated in FIG. 7), which may be a constituent part of a proposed power tool system. In particular, FIGS. 1 to 3 show handle pieces that may be a constituent part of the power tool (1). The user of the power tool (1) can grip the power tool (1) at the handle (7) and in this way hold or guide it. Preferably, a toothing (5) can be integrated in the handle (7) of the power tool (1), said toothing (5) being able to cooperate with a mating toothing (6) on the suction connection device (4) (see FIG. 4 onward) such that an adjustable connection is formed between the power tool (1) and suction connection device (4). The toothing (5) of the handle (7) of the power tool (1) comprises a series of teeth, i.e. protruding elements or regions, which can pass into engagement with recessed regions or depressions of the mating toothing (6) of the suction connection device (4), with the result that the connection can be formed.

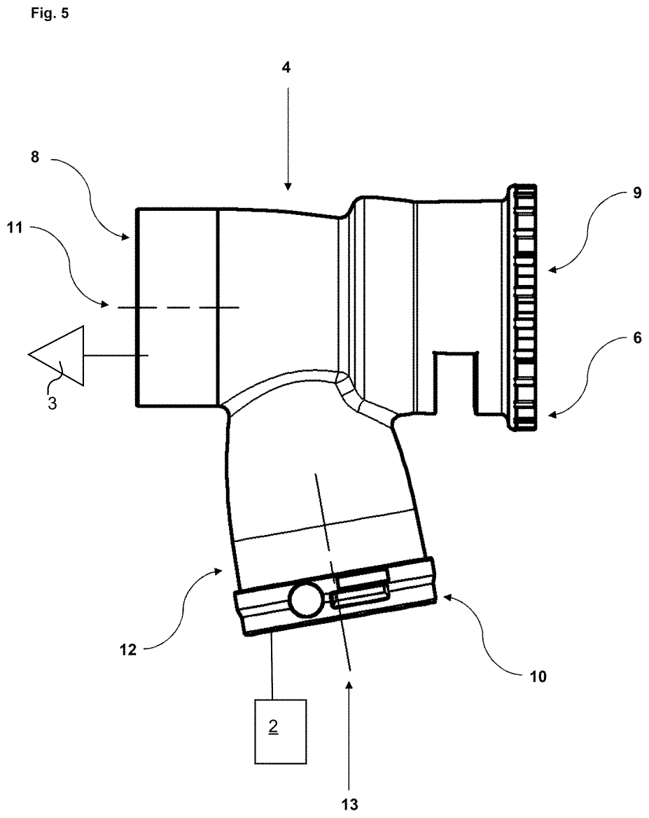

FIGS. 4 to 6 show preferred configurations of the suction connection device (4). In particular, FIG. 4 shows an oblique view of a preferred embodiment of a suction connection device (4). The suction connection device (4) can preferably be used for connecting the power tool (1) to its tool (3), for the one part, and for connecting the power tool (1) to a vacuuming device (2, illustrated solely schematically in FIG. 5), for the other part. Therefore, the suction connection device (4) preferably has three inputs or outputs, which are also referred to as connecting regions (8-10) according to the invention. According to the invention, it is preferred that the suction connection device (4) has a first connecting region (8) for connecting the suction connection device (4) to the tool (3) of the power tool (1). This first connecting region (8) is illustrated at the top right of FIG. 4. According to the invention, it is preferred that the first connecting region (8) and a second connecting region (9) are arranged along a central axis (11) within the suction connection device (4), wherein this central axis (11) may coincide preferably with the drive axis or drilling axis of the power tool (1). Preferably, the suction connection device (4) has a second connecting region (9) for connecting the suction connection device (4) to the power tool (1), wherein the power tool (1) may preferably also be configured as a core drill. Furthermore, the suction connection device (4) may have a third connecting region (10) for connecting the suction connection device (4) to a vacuuming device (2), wherein the vacuuming device (2) is preferably designed to extract the dust that accumulates during operation of the power tool (1) so as to prevent the dust from getting into the airways of a user.

The third connecting region (10) can preferably be formed by an extraction nozzle (12) or comprise an extraction nozzle (12). According to the invention, it is preferred that, theoretically, a virtual central axis (13) can pass through the suction connection device (4), in particular through the third connecting region (10) or the extraction nozzle (12) of the suction connection device (4), wherein this virtual central axis (13) is substantially perpendicular to the central axis (11), along which the first connecting region (8) and the second connecting region (9) are arranged. In other words, the central axis (11) and the virtual central axis (13) can be formed orthogonally to one another. The central axis (11) and the virtual central axis (13) are indicated by the dashed lines in FIGS. 4 to 6. The connection between the suction connection device (4) and vacuuming device (2) can be formed in particular using a suction hose (not illustrated), which can be connected to the suction connection device (4) for example by a latching mechanism. Preferably, the suction hose leads into the third connecting region (10) of the suction connection device (4).

Preferably, the suction connection device (4) is designed to bridge or fill a gap between the tool (3) of the power tool (1) and the tool (1) itself. Preferably, the suction connection device (4) forms a connecting piece, which can be arranged, in the manner illustrated in FIGS. 4 to 6, between the tool (3) and power tool (1). As a result, an adjustable connection between the tool (3) and power tool (1) can advantageously be provided by the proposed power tool system.

The suction connection device (4) comprises a mating toothing (6), which, according to the invention, can preferably also be referred to as mating contour. Preferably, the mating toothing (6) of the suction connection device (4) and the toothing (5) of the power tool (1) form a locking mechanism, which forms the connection between the power tool (1) and suction connection device (4). According to the invention, it is very particularly preferred that the connection between the power tool (1) and suction connection device (4) is formed between the suction connection device (4) and a handle (7) of the power tool (1).

FIG. 5 shows a side view of a preferred embodiment of the suction connection device (4).

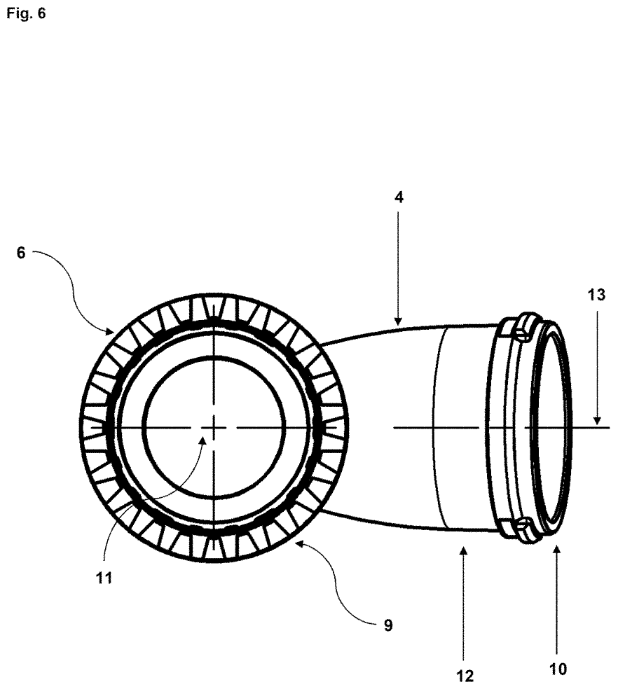

FIG. 6 shows a further view of a preferred embodiment of the suction connection device (4). The view illustrated in FIG. 6 shows in particular the second connecting region (9) of the suction connection device (4), which is designed to establish the connection between the suction connection device (4) and power tool (1) or a handle (7) of the power tool (1). The first connecting region (8) of the suction connection device (4), which is preferably designed to establish a connection between the suction connection device (4) and tool (3), is not illustrated in FIG. 6 but illustrated solely schematically in FIG. 5. In the right-hand half of FIG. 6, the third connecting region (10) is illustrated, which is preferably configured as an extraction nozzle (12). The third connecting region (10) forms preferably the transition from the suction connection device (4) to a vacuuming device (2), wherein the connection can be established in particular by a suction hose.

FIG. 7 shows a preferred embodiment of the proposed power tool system, but without tool (3). In particular, FIG. 7 shows the suction connection device (4), which is connected to a power tool (1). The suction connection device (4) has a mating toothing (6), which can be engaged with a toothing (5) of the handle (7) of the power tool (1), with the result that advantageously a locking mechanism is produced. The locking mechanism is located preferably in the second connecting region (9) of the proposed power tool system. In FIG. 7, the central axis (11) can be seen in the first connecting region (8) of the suction connection device (4), the first connecting region (8) and the second connecting region (9) being able to be arranged along said central axis (11). A virtual central axis (13), which may in particular be perpendicular to the central drive axis (11), extends preferably through the third connecting region (10) or the extraction nozzle (12) of the suction connection device (4). Proceeding from the third connecting region (10), the suction connection device (4) can be connected to a vacuuming device (2). For this purpose, use can be made in particular of a suction hose.

### LIST OF REFERENCE SIGNS

1 Power tool
2 Vacuuming device
3 Tool
4 Suction connection device
5 Toothing
6 Mating toothing
7 Handle
8 First connecting region
9 Second connecting region
10 Third connecting region
11 Central axis (drive axis)
12 Extraction nozzle
13 Virtual central axis

1-14. (canceled)

15. A power tool system comprising:
a power tool;
a tool;
a vacuuming device for extracting dust arising when working with the power tool;
a suction connection device, the suction connection device being arranged between the tool and the power tool and connectable to the power tool so that a toothing of the power tool is engagable with a mating toothing on the suction connection device.

16. The power tool system as recited in claim 15 wherein the toothing of the power tool cooperates with the mating toothing on the suction connection device in such a way that at least three fastening stages are settable.

17. The power tool system as recited in claim 16 wherein the at least three fastening stages include:
a first fastening stage where a handle of the power tool and the suction connection device are fixed together;
a second fastening stage where the handle of the power tool and the suction connection device form a unit configured to be rotatable relative to the power tool; and
a third fastening stage where the suction connection device is configured to be rotatable relative to the handle of the power tool.

18. The power tool system as recited in claim 16 wherein the fastening stages are settable by a number of rotations of the handle of the power tool.

19. The power tool system as recited in claim 15 wherein the suction connection device has a first connecting region for connecting the suction connection device to the tool.

20. The power tool system as recited in claim 19 wherein the suction connection device has a second connecting region for connecting the suction connection device to the power tool.

21. The power tool system as recited in claim 20 wherein the first and the second connecting region are arranged along a central axis of the power tool.

22. The power tool system as recited in claim 20 wherein the suction connection device has a third connecting region for connecting the suction connection device to the vacuuming device.

23. The power tool system as recited in claim 22 wherein the third connecting region includes an extraction nozzle.

24. The power tool system as recited in claim 22 wherein a virtual central axis of the third connecting region is perpendicular to a central axis along which the first and the second connecting region are arranged.

25. The power tool system as recited in claim 15 wherein the suction connection device includes a connection for a vacuuming device.

26. The power tool system as recited in claim 15 wherein the toothing is integrated in the handle of the power tool.

27. The power tool system as recited in claim 15 wherein the toothing is designed to engage in the mating toothing of the suction connection device.

28. The power tool system as recited in claim 15 wherein the suction connection device has a connecting region for connecting the suction connection device to the power tool.

29. The power tool system as recited in claim 15 wherein the suction connection device has a connecting region for connecting the suction connection device to the vacuuming device.

30. A method for connecting a vacuuming device to a power tool, the method comprising the following steps:
a) providing a power tool and a tool;
b) providing a suction connection device arranged between the tool and the power tool;
c) establishing a connection between the suction connection device and the power tool so that a toothing of the power tool is engaged with a mating toothing on the suction connection device.
